(19) United States
(12) Patent Application Publication
(10) Pub. No.: US 2003/0043577 A1
(43) Pub. Date: Mar. 6, 2003

(54) Retaining device for an ornamental light

(76) Inventor: Jeou-Nan Tseng, Hsinchu City (TW)

Correspondence Address: VENABLE, BAETJER, HOWARD AND CIVILETTI, LLP, P.O. BOX 34385, WASHINGTON, DC, 20043-9998, US

(21) Appl. No.: 09/942,783

(22) Filed: Aug. 31, 2001

(51) Int. Cl. F21V 21/00

(52) U.S. Cl. 362/226; 362/396

(57) ABSTRACT

A retaining device for an ornamental light has a plug, a clip and an ear. The plug is securely inserted into the seat and has two grooves formed on opposite sides of the plug. The clip is integrally formed with the plug and has two jaws extending perpendicular to the plug and parallel to each other. The ear is integrally formed with the plug and is opposite to the clip.

### BACKGROUND OF THE INVENTION

1. Field of the Invention

The present invention relates to a retaining device, and more particularly to a retaining device for an ornamental light. The retaining device is formed on a plug inserted into a seat used to connect electrical wires to the bulb so that the retaining device can be firmly attached to a proper object.

2. Description of Related Art

Christmas lights or ornamental lights are normally wrapped around a tree, a fence, a roof edge or other suitable object by the wires. With the flexibility of the wires, the lights are able to be attached to the object properly to enhance the decorative effect. However, when the wires are stretched by strong wind such as in a typhoon or hurricane, the wires will be easily broken or pulled out of the sockets and break the circuit. To obviate the problem, a new kind of retaining device was invented. The new retaining device has at least two semicircular loops each extending out from opposite sides of the seat so that each light can be attached to the wires of another light. With such an arrangement, a net-like structure can be implemented. With the assistance of the other light, the wind resistance of the ornamental light is enhanced. However, it is noted that the wind resistance of the ornamental light still depends on the strength of two wires and their connection. That is, the wind resistance of this ornamental light is based on the stretch of two adjacent wires on two different lights. Still, this structure risks wire breakage under the same situation as previously described.

To overcome the shortcomings, the present invention tends to provide an improved retaining device to mitigate and obviate the aforementioned problems.

### SUMMARY OF THE INVENTION

The primary objective of the invention is to provide a retaining device to enable the ornamental light to be attached to an object without using the connecting wires.

To accomplish the foregoing objective, the retaining device has at least one ear integrally formed with a plug inserted into the seat of the ornamental light so that the light itself is able to be attached to an object.

According to another aspect of the invention, the retaining device has a clip integrally formed with a plug that is inserted into the seat of the ornamental light so the light itself is able to be attached to an object.

According to still another aspect of the invention, the retaining device has at least one ear and a clip integrally formed with a plug inserted into the seat and extending opposite from each other so that the light is able to attach to an object itself.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of the retaining device of the present invention;

FIG. 2 is an exploded perspective view of the retaining device in FIG. 1;

FIG. 3 is a side plan view in partial section of the retaining device in FIG. 1;

FIG. 4 is a side plan view of another preferred structure of the retaining device in FIG. 1;

FIG. 5 is a perspective view of a second embodiment of the retaining device in accordance with the present invention;

FIG. 6 is an exploded perspective view of the retaining device in FIG. 5;

FIG. 7 is a side plan view in partial section of the retaining device in FIG. 5;

FIG. 8 is a side plan view of another embodiment of the retaining device in FIG. 5;

FIG. 9 is a perspective view of a third embodiment of the retaining device in accordance with the present invention;

FIG. 10 is an exploded perspective view of the retaining device in FIG. 9;

FIG. 11 is a side plan view of the retaining device in FIG. 9; and

FIG. 12 is a side plan view in partial section of another embodiment of the retaining device in FIG. 9.

### DETAILED DESCRIPTION OF THE PREFERRED EMBODIMENT

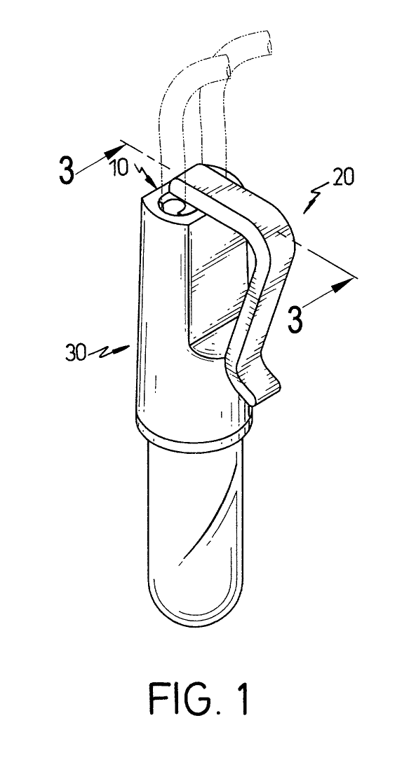

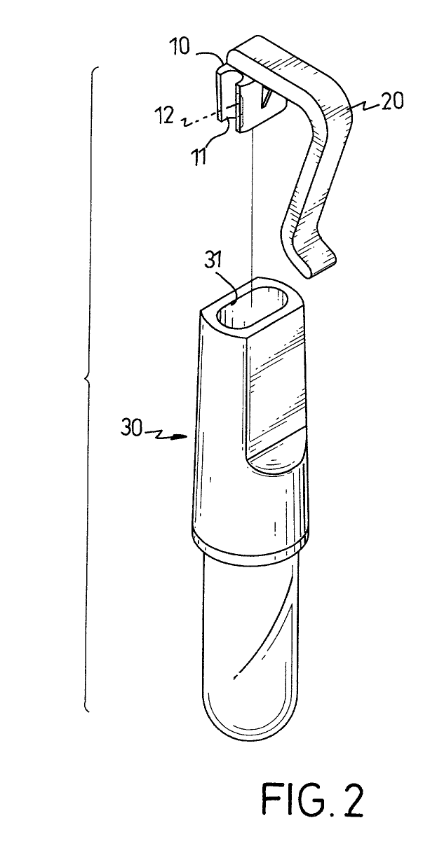

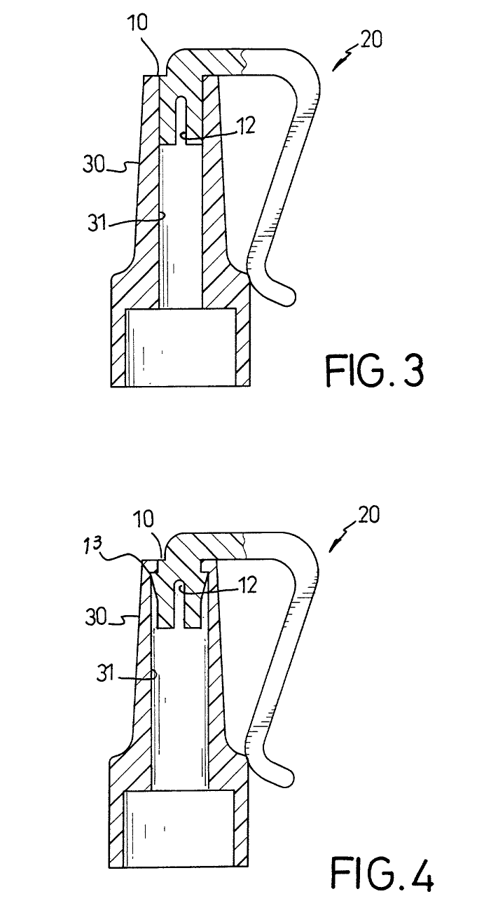

With reference to FIGS. 1, 2 and 3, a first preferred embodiment of the retaining device of the present invention has a plug (10) and an ear (20).

The plug (10) is adapted to be mounted in a channel (31) of a cylindrical seat (30) and has a groove (11) defined in each side of the plug (10) to allow wires (not numbered) to pass through the plug (10).

The ear (20) is integrally formed with the plug (10) and is made of a resilient material.

When the retaining device is assembled, the plug (10) is pressed into the channel (31) of the seat (30). To increase the flexibility of the plug (11) so it can be more easily inserted into the channel (31) because the plug (10) has a dimension slightly larger than that of the channel (31), a slot (12) is centrally defined in the plug (11). Further, with reference to FIG. 4, two barbs (13) are formed on opposite faces of the plug (10) so that when the plug (10) is inserted into the channel (31) in the seat (30), the barbs (13) increase the interference fit of the plug (10) inside the channel (31).

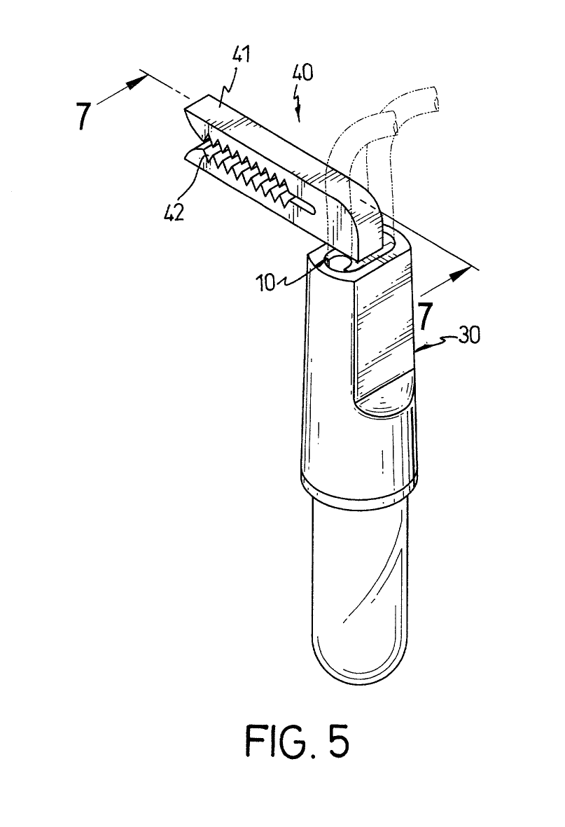

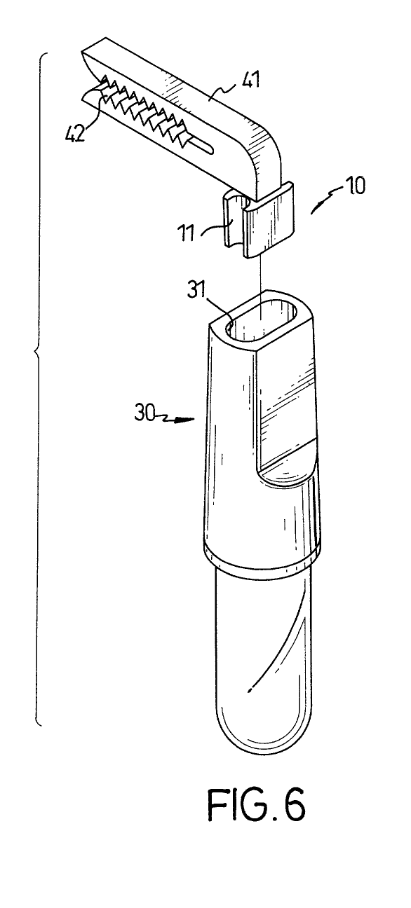

With reference to FIGS. 5 and 6, a second embodiment of the retaining device in accordance with the present invention comprises a plug (10) and a clip (40).

The plug (10) is adapted to be received in a channel (31) in a seat (30) and has a groove (11) defined in each side of the plug (10) to allow wires (not numbered) to pass through the plug (10).

The clip (40) is integrally formed of a resilient material with the plug (10) and has two jaws (41) extending perpendicular to the plug (10) and parallel to each other. Each of the jaws (41) has teeth along an inner side face (42) corresponding to each other.

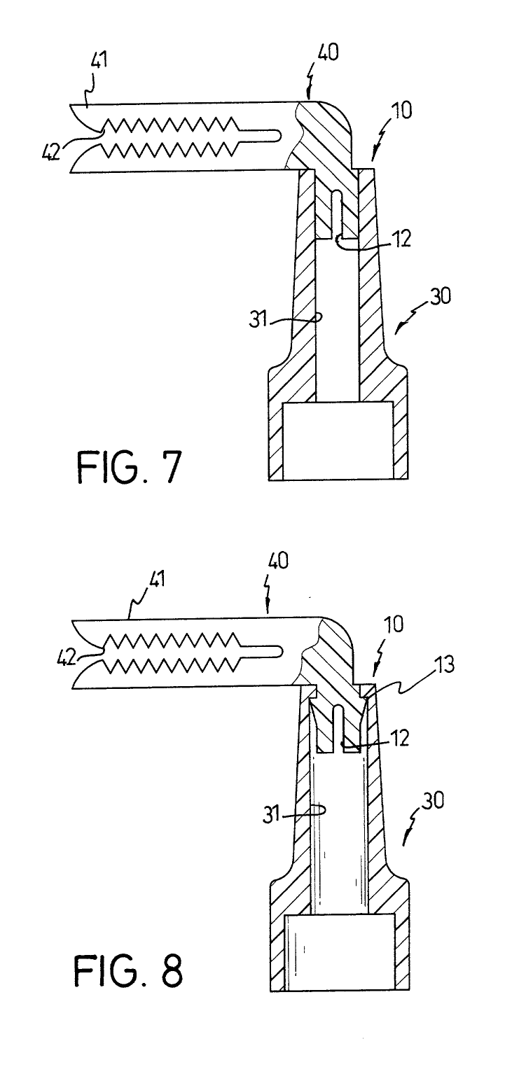

With reference to FIGS. 7 and 8, to improve the engagement between the plug (10) and the inner face defining the channel (31) when the retaining device is inserted into the channel (31) in the seat (30), a dimension of the plug (10) is slightly larger than that of the channel (31) and a slot (12) is centrally defined inside the plug (10). The insertion of the plug (10) into the channel (31) in the seat (30) forces the plug (10) to deform, and thus the plug (10) is able to be securely held in the channel (31). With reference to FIG. 8, two barbs (13) are formed on opposite faces of the plug (10) so that when the plug (10) is inserted into the channel (31) in the seat (30), the barbs (13) improve the engagement between the plug (10) inside the channel (31).

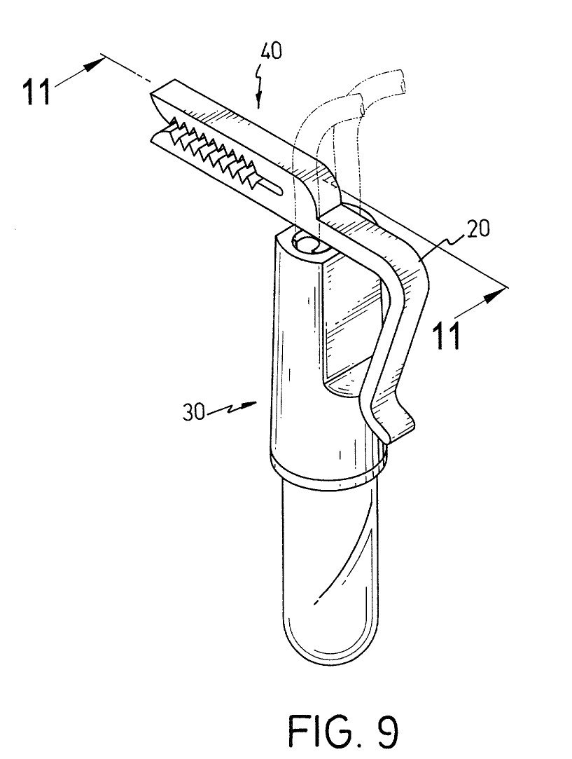

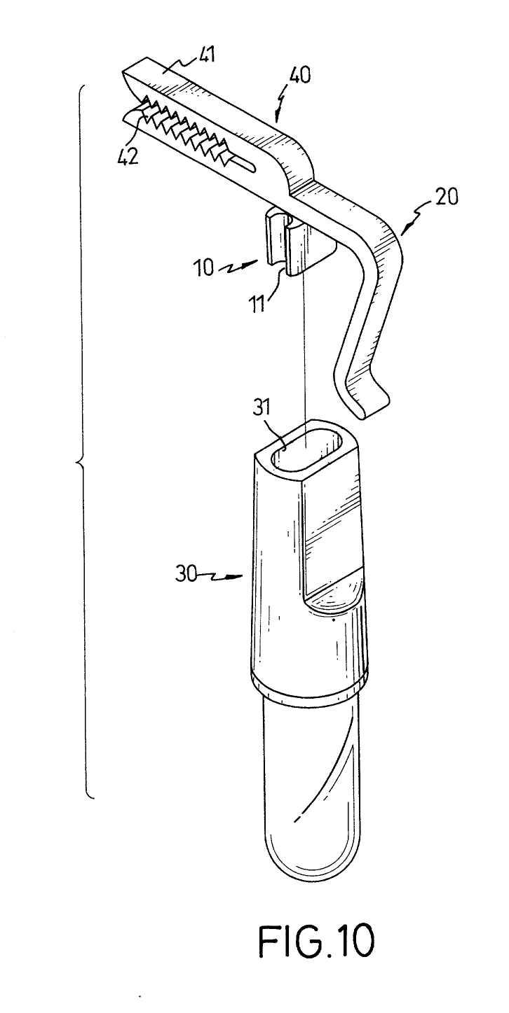

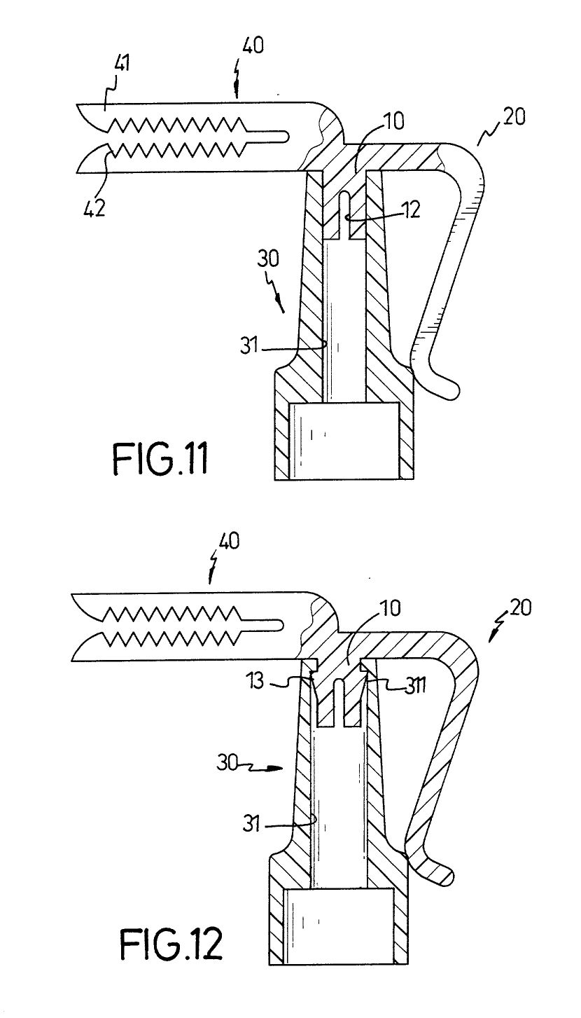

With reference to FIGS. 9 to 12, a third embodiment of the retaining device in accordance with the present invention has a plug (10), an ear (20) and a clip (40).

The plug (10) is adapted to be received in a channel (31) in a seat (30) and has a groove (11) defined in each side of the plug (10) to allow wires (not numbered) to pass through the plug (10).

The ear (20) and the clip (40) are integrally formed with the plug (10) and are made of a resilient material.

The clip (40) has two jaws (41) extending perpendicular to the plug (10) and parallel to each other. Each of the jaws (41) has teeth along an inner side face (42) corresponding to each other.

To improve the engagement between the plug (10) and the inner face defining the channel (31) when the retaining device is inserted into the channel (31) in the seat (30), a dimension of the plug (10) is slightly larger than that of the channel (31) and a slot (12) is centrally defined inside the plug (10). The insertion of the plug (10) into the channel (31) in the seat (30) forces the plug (10) to deform, and thus the plug (10) is able to be securely held in the channel (31). Furthermore, two barbs (13) are formed on opposite faces of the plug (10) so that when the plug (10) is inserted into the channel (31) in the seat (30), the barbs (13) improve the engagement between the plug (10) inside channel (31). A further improvement in the engagement between the plug (10) and the seat (30) is to have a pair of recesses (311) oppositely defined in an inner wall of the channel (31) so that when the plug (10) is inserted into the channel (31), the barbs (13) are able to be received in the corresponding recesses (311).

The retaining device of the present invention has the following advantages.

Simple Structure:

The retaining device of the present invention is integrally formed with the plug which is original a part of the conventional ornamental light, which makes the entire ornamental light compact and simple.

Enhanced Durability:

Because the ornamental light is attached to an appropriate object with the retaining device, the durability of the light is prolonged and enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A retaining device for an ornamental light having a cylindrical seat, the retaining device comprising:
a plug securely inserted into the seat and having two grooves on opposite sides of the plug; and
an ear integrally formed with the plug.

2. The retaining device as claimed in claim 1, wherein the plug further has slot centrally defined in the plug to enhance the resilience of the plug when inserted into the seat.

3. The retaining device as claimed in claim 2, wherein the plug further has two barbs each formed on opposite sides of the plug to increase the engagement between the plug and the seat after the plug is inserted into the seat.

4. A retaining device for an ornamental light having a cylindrical seat, the retaining device comprising:
a plug securely inserted into the seat and having two grooves on opposite sides of the plug; and
a clip integrally formed on the plug and having two jaws extending perpendicular to the plug and parallel to each other, wherein each of the jaws has teeth along an inner side face corresponding to each other.

5. The retaining device as claimed in claim 4, wherein the plug further has slot centrally defined in the plug to enhance the resilience of the plug when inserted into the seat.

6. The retaining device as claimed in claim 5, wherein the plug further has two barbs each formed on two opposed sides of the plug to increase the engagement between the plug and the seat after the plug is inserted into the seat.

7. A retaining device for an ornamental light having a cylindrical seat, the retaining device comprising:
a plug securely inserted into the seat and having two grooves on opposite sides of the plug;
a clip integrally formed on the plug and having two jaws extending perpendicular to the plug and parallel to each other, wherein each of the jaws has teeth along an inner side face corresponding to each other; and
an ear integrally formed with the plug and opposite to the clip.

8. The retaining device as claimed in claim 7, wherein the plug further has slot centrally defined in the plug to enhance the resilience of the plug when inserted into the seat.

9. The retaining device as claimed in claim 8, wherein the plug further has two barbs each formed on opposite sides of the plug to increase the engagement between the plug and the seat after the plug is inserted into the seat.
